(19) United States
(12) Patent Application Publication
(10) Pub. No.: US 2026/0257603 A1
(43) Pub. Date: Sep. 3, 2026

(54) Head Support of a Vehicle Seat

(71) Applicant: Bayerische Motoren Werke Aktiengesellschaft, Muenchen (DE)

(72) Inventors: Jens HILDENBRAND, Unterfoehring (DE); Felix KOPPMANN, Muenchen (DE); Michael LENG, Geltendorf (DE)

(21) Appl. No.: 18/834,657

(22) PCT Filed: Mar. 28, 2023
(86) PCT No.: PCT/EP2023/057963

§ 371 Date: Jul. 31, 2024

(30) Foreign Application Priority Data
Apr. 6, 2022 (DE) 10 2022 108 245.8

(51) Int. Cl. B60N 2/888

(52) U.S. Cl. CPC B60N 2/888

(57) ABSTRACT

A head support of a vehicle seat has a support structure which introduces an impact force into the structure of the vehicle seat in the event of a head impacting the head support and which has an impact body that supports the impact of the head. A head support cushion is provided on the impact body face facing the head of a passenger sitting on the vehicle seat.

An outer skin encases the head support. An active support system is provided on the impact body face facing the head of the passenger. The support mechanism displaces lateral regions of the head support cushion forwards towards the head in the event of a head impacting the head support. The support mechanism has a flexible actuator element which extends in the transverse direction and which is designed to be brought from an inactive state into an active state by way of the impact force exerted by the head impacting the head support in the event of a vehicle collision, and the lateral free end regions of the actuator element face the head of the passenger in the active state.

### BACKGROUND AND SUMMARY

The invention relates to a vehicle seat head restraint having a support structure which, in a case of a head impact against the head restraint, introduces an impact force into a structure of the vehicle seat and having an impact body that supports the head impact. A head restraint cushion is provided at least on a side of the impact body facing the head of a passenger sitting in the vehicle seat. It also relates to a vehicle seat provided with a head restraint of this type and to a vehicle, in particular a motor vehicle, having at least one such vehicle seat.

The direction indication “front” in the description below means the straight-ahead direction of view of a passenger sitting in a vehicle seat; accordingly, “rear” is the opposite direction. In the case of a vehicle seat facing in the forward direction of travel of the vehicle, these direction indications match the vehicle-related direction indications “front” and “rear”; in the case of a vehicle seat facing opposite the forward direction of travel, the vehicle-related direction indications are opposite the direction designations related to the vehicle seat.

For reasons of comfort, head restraints of vehicle seats are typically designed such that they have, on the side facing a passenger sitting in the associated vehicle seat, a substantially flat front side with a head restraint cushion of constant thickness. Since the occiput of a human is generally not flat but rather has a more or less rounded form, when the occiput impacts a head restraint an initially nearly punctiform load between the occiput and the head restraint cushion and ultimately the head restraint structure arises.

FIG. 1 shows this situation. The head K of a passenger P sitting in a vehicle seat 1′ is abruptly moved rearward and caught by the head restraint 2′ when an obstacle or another vehicle impacts the vehicle from the rear, i.e.—in the case of a vehicle seat 1′ facing in the direction of travel F—when a rear impact occurs. The occiput H hits the head restraint 2′ initially nearly in a punctiform manner (solid lines) and subsequently compresses the head restraint cushion 20′ in this location, whereby the motion of the head K is decelerated and part of the kinetic energy of the head is dissipated over the compression travel distance of the head restraint cushion 20′. The rest of the kinetic energy of the head is abruptly dissipated at the end of the compression phase of the head restraint cushion 20′, when the compressed head restraint cushion 20′ and an inner, hard impact body 30′ of a support structure 3′ of the head restraint 2′ stop the motion of the head K (dashed lines).

In order to be able to dissipate more kinetic energy by means of the head restraint cushion beforehand, the hardness of the head restraint cushion could be increased, but this is contrary to the desired level of comfort in normal operation. Alternatively, the shape of the head restraint on its front side could be changed such that it is more highly adapted to the occiput shape, i.e. is more concave, and offers the head greater contact area, so that more cushion volume is available for dissipating the kinetic energy. However, such a concave front side of the head restraint is likewise undesired in normal operation of the vehicle, for reasons of comfort and aesthetics. Also, a thicker head restraint cushion on the front side of the head restraint is usually not possible for reasons of design and/or comfort, because of the limited available installation space.

A head-restraint-type device for protecting a head in the vehicle interior in the event of an accident is known from German utility model DE G 83 33 127.1 U1. This known device has a pair of a left and a right pivot lever concealed in the interior of the head restraint under the head restraint cushion and having a central actuation portion on which the striking force of the head acts, which striking force consequently causes the free end portion of the respective pivot lever to pivot frontward, whereby the cushion of the head restraint forms a helmet-like casing of the head on the top side and the left and right sides of the head. However, this does not enlarge the striking area of the head on the head restraint, so the forces acting on the head form locally high force peaks.

The object of the present invention is to design a head restraint of the type in question which belongs to a vehicle seat facing in the direction of travel, such that, in the event of a rear impact against the vehicle and the resulting striking of the head restraint by the head, an improved decelerating effect on the head is achieved.

This object is achieved by the features of the independent claim(s).

A head restraint of a vehicle seat, comprising: a support structure which, in the case of a head impact against the head restraint, introduces the impact force into the structure of the vehicle seat and which has an impact body that supports the head impact; a head restraint cushion which is provided at least on the side of the impact body facing the head of a passenger sitting in the vehicle seat; and an outer skin which encases the head restraint; wherein, on the side of the impact body facing the head of the passenger, an active support mechanism is provided which moves side regions of the head restraint cushion frontward toward the head during the head impact against the head restraint; is characterized in that the support mechanism has a flexible actuator element which extends in the transverse direction and which is designed such that, in the case of a vehicle collision, the actuator element can be brought from an inactive state into an active state as a result of the impact force applied by the head impacting the head restraint, wherein, in the active state, the lateral free end regions of the actuator element point toward the head of the passenger.

The special design of the actuator element according to the invention has the effect that the passenger's occiput darting rearward against the head restraint hits the central region of the flexible actuator element and thereby bends the actuator element such that its free end regions dart frontward. In the process, the free, lateral end regions of the actuator element laterally apply the head cushion material located in front of them to the occiput, so that the occiput is extensively supported and caught by the cushion material as the occiput moves rearward. Thus, the contact area of the head is enlarged and the acceleration load of the head is thereby correspondingly reduced.

Additional preferred and advantageous design features of the head restraint according to the invention are the subject matter of the dependent claims.

According to a first variant, the actuator element is preferably formed by or comprises a folding element which is supported, in a central region, on two laterally mutually spaced support elements by means of two support portions, said support elements being provided on the impact body to the left and right of a vertical longitudinal center plane of the head restraint, and if the folding element is provided with a folding site in its central portion located between the support portions. The folding element therefore folds when the head impacts the head restraint and thus the central region of the folding element, wherein the lateral free end regions are moved frontward and move the cushion material located in front of them toward the head.

The folding site is preferably a plastically deformable region of the monolithic folding element.

Alternatively, the folding site is an elastically deformable region of the monolithic folding element.

In another alternative, the folding site of the folding element is formed by a hinge.

According to a second variant of the head restraint according to the invention, the actuator element is or comprises a monolithic bistable spring element which assumes, in the inactive state, a first stable state in which the bistable spring element is convex and curves toward the head and, in the active state, a second stable state in which the bistable spring element is concave and curves away from the head, wherein the bistable spring element is supported, in a central region, on two laterally mutually spaced support elements by means of two support portions, said support elements being provided on the impact body ( ) to the left and right of a vertical longitudinal center plane of the head restraint, wherein the bistable spring element forms, in its central portion located between the support portions, a triggering region for the switchover between the two bistable states. The use of such a bistable spring element as an actuator element has the advantage that the bistable spring element does not have to be replaced after a switchover or changeover into the second active state, but rather merely has to be brought back into the first, inactive state.

It is particularly advantageous if the lateral end regions of the spring element point, in the first stable state, rearward away from the head and, in the second stable state, frontward toward the head.

It is also particularly advantageous if the spring element is formed by a spring plate, as a result of which both a large central impact area and large actuator areas in the lateral regions of the spring element are available.

The invention is also directed to a vehicle seat having a head restraint of this type and to a vehicle, in particular a motor vehicle, having at least one such vehicle seat.

Preferred exemplary embodiments of the invention with additional design details and with additional advantages are described and explained in more detail below with reference to the enclosed drawings.

### BRIEF DESCRIPTION OF THE DRAWINGS

FIG. 1 is a schematic top-view illustration of a head restraint according to the prior art, during impact of an occiput against the head restraint with initially nearly punctiform load;

FIG. 2 is a schematic top-view illustration of a first variant of a head restraint according to the invention in its inactive state;

FIG. 3 is a schematic top-view illustration of the first variant of the head restraint according to the invention in its active state;

FIG. 4 is a schematic top-view illustration of a second variant of a head restraint according to the invention in its inactive state; and

FIG. 5 is a schematic top-view illustration of the second variant of the head restraint according to the invention in its active state.

### DETAILED DESCRIPTION OF THE DRAWINGS

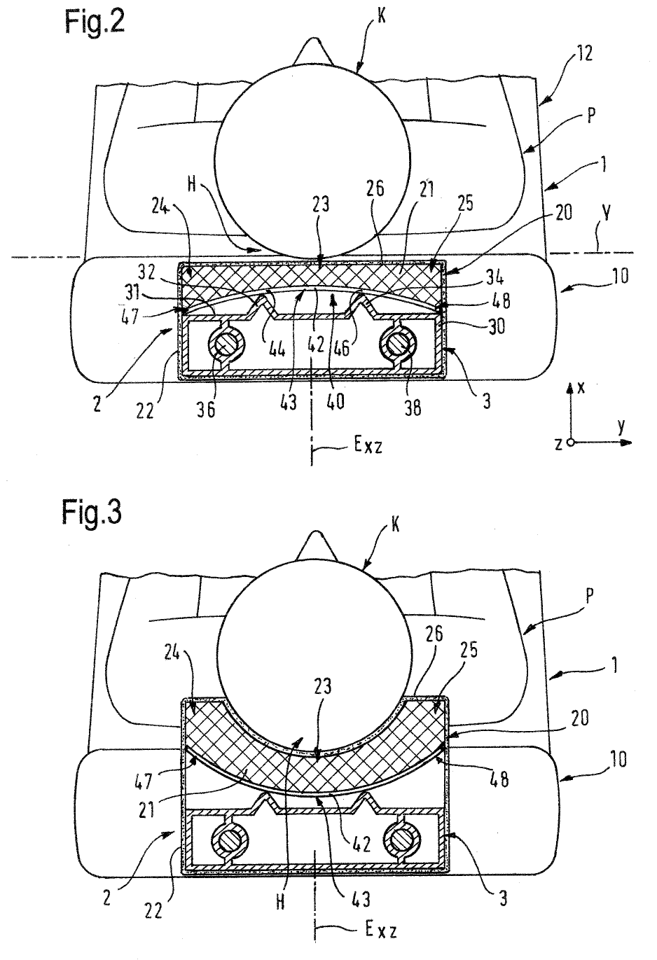

FIG. 2 shows a first variant of a head restraint according to the invention in a schematic top-view illustration, in the inactive state of the head restraint 2. The head restraint has a support structure 3, by means of which the head restraint 2 is fastened to the seat backrest 10 of the vehicle seat 1 in a conventional way. The seat backrest 10 is attached, likewise in a conventional way, to the seat bottom 12 of the vehicle seat, for example in such a way that the seat backrest can be tilted about a transverse axis y.

The support structure 3 of the head restraint 2 comprises, in the interior of the head restraint 2, an impact body 30 which, for example, is made of a metal. This impact body 30 comprises, on its front side 31 facing a passenger P sitting in the vehicle seat, two support elements 32, 34 which protrude frontward and which are mutually spaced apart laterally, i.e. in the transverse direction Y, and which are equidistant from a vertical longitudinal center plane Exz of the vehicle seat 1, i.e. are arranged symmetrically with respect to this vertical longitudinal center plane Exz. The support elements 32, 34 can be acute-angled or curved wall portions formed out of the impact body 30, as shown in the figures, or they can be formed by independent bodies which are connected to the impact body 30. The impact body 30 is, for example, height-adjustably connected to the inner structure of the seat backrest 10 by means of support rods 36, 38 which are led into the seat backrest 10 from above. However, the impact body 30 can also be rigidly connected to the inner structure of the seat backrest 10; this is practical in particular when the head restraint 2 is formed integrally with the seat backrest 10.

On the front side of the impact body 30, a head restraint cushion 20 having a foam core 21 is provided. This foam core 21 is surrounded by a head restraint cover 22, which also surrounds the impact body 30 and which forms the outer casing of the head restraint 2. The head restraint cover 22 is elastic in order to participate when, as described below, lateral regions 24, 25 of the head restraint cushion 20 are moved forward.

On the rear side of the foam core 21 of the head restraint cushion 20, a flexible actuator element 40 is provided, which, in a central region 43, abuts the first support element 32 by means of a first support portion 44 and abuts the second support element 34 by means of a second support portion 46 spaced apart from the first support portion and is supported thereagainst.

In the example of a first variant of the head restraint 2 according to the invention, which example is shown in FIGS. 2 and 3, the actuator element 40 is formed by a bistable spring element 42, which in FIG. 2 is shown in an inactive state in which the lateral free end regions 47, 48 point rearward, i.e. away from the head K of the passenger P.

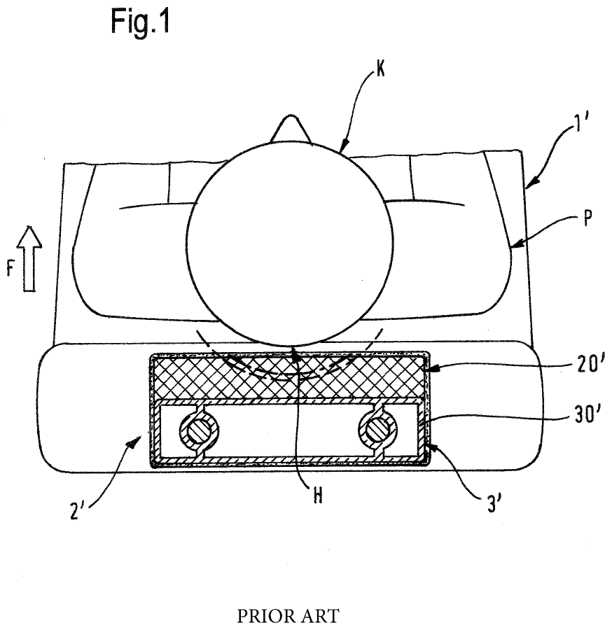

Then, if a shock in the direction X which is applied to the seat from the rear causes the head K of the passenger P to hit the front side 26 of the head restraint 2 under the influence of inertia, the occiput H—as described in connection with the example of FIG. 1—is pressed against the head restraint cushion 20 and compresses the head restraint cushion 20. However, before the occiput H comes into contact with the impact body 30, the compressed central region 23 of the head restraint cushion 20 presses on the central region 43 of the bistable spring element 42, which central region forms, in a central portion, a triggering region for the switchover between the two stable states of the bistable spring element 42, whereupon the bistable spring element 42 changes over from its inactive state, which is illustrated in FIG. 2, to its active state, which is illustrated in FIG. 3 and in which the lateral free end regions 47, 48 of the bistable spring element 42 point frontward. At the same time, the lateral free end regions 47, 48 of the bistable spring element 42 press the lateral regions 24, 25 of the head restraint cushion 20 frontward, so that the head restraint cushion 20 extensively contacts the occiput H of the passenger P. As a result, the rearward-moving head K of the passenger P is decelerated by the head restraint cushion 20 over a much greater contact area than in the example of FIG. 1, since a much larger volume of the foam core 21 is compressed by the head K.

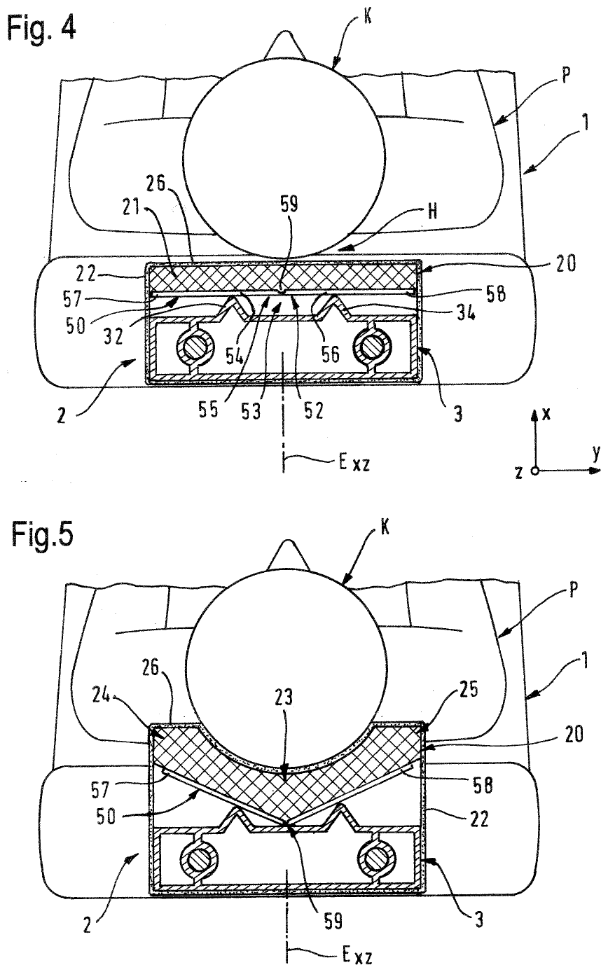

FIGS. 4 and 5 show a second variant of the head restraint 2 according to the invention in an inactive state (FIG. 4) and in an active state (FIG. 5). The vehicle seat 1, the head restraint 2 and the support structure 3 correspond, with the exception of the actuator element 50, to the first variant, which is shown in FIGS. 2 and 3 and is described in connection with those figures. Therefore, for unchanged components the same reference signs as in FIGS. 2 and 3 are used, and for these components the description of FIGS. 2 and 3 also applies to the second variant.

The head restraint 2 of the second variant has, as a flexible actuator element 50, a folding element 52 which is supported on the first support element 32 by means of a first support portion 54 and on the second support element 34 by means of a second support portion 56 laterally spaced apart from the first support portion. The two lateral free end regions 57, 58 of the folding element 52 point substantially straight to the left side and to the right side, respectively, in the transverse direction Y of the head restraint 2.

If the occiput H of the passenger P impacts the front side 26 of the head restraint 2 from the front toward the rear, the occiput H compresses the foam core 21 of the head restraint cushion 20 and presses, in the central region 23 of the head restraint cushion 20, against the central region 53 of the folding element 52, which is provided with a folding site 59 in a central portion 55. This folding site 59 can be plastically deformable, elastically deformable or formed by a hinge.

As a result of the force acting on the folding element 52 in the central region 53, the folding element 52 folds at the folding site 59 and the fold comes into contact with the impact body 30, as is shown in FIG. 5, whereby, because of the lever effect about the contact points on the respective support elements 32, 34, the lateral free end portions 57, 58 of the folding element 52 shift frontward and move the foam core 21 of the head restraint cushion 20 frontward in the lateral regions 24, 25 of the head restraint cushion and thus apply the head restraint cushion 20 to the occiput H of the passenger P extensively. This too has the effect that, like in the example of FIGS. 2 and 3, the head K is decelerated on a larger area of the head restraint cushion 20 with a larger foam core volume, and in the example of this variant—like in the first variant—this leads to considerably improved deceleration of the rearward motion of the head K in comparison with the classic embodiment according to FIG. 1.

The invention is not limited to the exemplary embodiment above, which serves merely to generally illustrate the core idea of the invention. Rather, within the scope of protection the device according to the invention can also assume other embodiments than those described above. The device can have, in particular, features which are a combination of the respective individual features of the claims.

Reference signs in the claims, in the description and in the drawings are intended merely to provide better understanding of the invention and are not intended to limit the scope of protection.

### LIST OF REFERENCE SIGNS

1 Vehicle seat
2 Head restraint
3 Support structure
10 Seat backrest
12 Seat bottom
20 Head restraint cushion
21 Foam core
22 Head restraint cover
23 Compressed central region
24 Lateral region of the head restraint cushion
25 Lateral region of the head restraint cushion
26 Front side of 20
30 Impact body
31 Front side
32 Support element
34 Support element
36 Support rod
38 Support rod
40 Flexible actuator element
42 Bistable spring element
43 Central region of the bistable spring element
44 First support portion
46 Second support portion
47 Lateral free end region
48 Lateral free end region
50 Flexible actuator element
52 Folding element
53 Central region of the folding element
54 First support portion
55 Central portion
56 Second support portion
57 Folding site
58 Lateral free end region of the folding element
EXY Vertical longitudinal center plane
F Direction of travel
H Occiput
K Head
P Passenger
X Longitudinal direction
y Transverse axis
Y Transverse direction

1.-10. (canceled)

11. A head restraint of a vehicle seat, comprising:
a support structure which, in a case of a head impact against the head restraint, introduces an impact force into a structure of the vehicle seat and which has an impact body that supports the head impact;
a head restraint cushion which is provided at least on a side of the impact body facing the head of a passenger sitting in the vehicle seat;
an outer skin which encases the head restraint;
an active support mechanism provided on the side of the impact body facing the head of the passenger, which active support mechanism moves side regions of the head restraint cushion frontward toward the head during the head impact against the head restraint,
wherein the active support mechanism comprises a flexible actuator element which extends in a transverse direction and which is designed such that, in the case of a vehicle collision, the flexible actuator element is brought from an inactive state into an active state as a result of the impact force applied by the head impacting the head restraint, and
wherein, in the active state, lateral free end regions of the actuator element point toward the head of the passenger.

12. The head restraint according to claim 11, wherein
the flexible actuator element comprises a folding element which is supported, in a central region, on two laterally mutually spaced support elements via two support portions, said support elements being provided on the impact body to the left and right of a vertical longitudinal center plane of the head restraint, and
the folding element is provided with a folding site in a central portion located between the two support portions.

13. The head restraint according to claim 12, wherein
the folding site is a plastically deformable region of a monolithic folding element.

14. The head restraint according to claim 12, wherein
the folding site is an elastically deformable region of a monolithic folding element.

15. The head restraint according to claim 12, wherein
the folding site of the folding element is formed by a hinge.

16. The head restraint according to claim 11, wherein
the actuator element comprises a monolithic bistable spring element which assumes, in the inactive state, a first stable state in which the bistable spring element is convex and curves toward the head and, in the active state, a second stable state in which the bistable spring element is concave and curves away from the head, and
the bistable spring element is supported, in a central region, on two laterally mutually spaced support elements via two support portions, said support elements being provided on the impact body to the left and right of a vertical longitudinal center plane of the head restraint,
wherein the bistable spring element forms, in a central portion located between the support portions, a triggering region for the switchover between the two bistable states.

17. The head restraint according to claim 16, wherein
the lateral end regions of the spring element point, in the first stable state, rearward away from the head and, in the second stable state, frontward toward the head.

18. The head restraint according to claim 16, wherein
the bistable spring element is formed by a spring plate.

19. A vehicle seat comprising a head restraint according to claim 11.

20. A vehicle comprising at least one vehicle seat according to claim 19.
